(19) United States
(12) Patent Application Publication
(10) Pub. No.: US 2012/0292075 A1
(43) Pub. Date: Nov. 22, 2012

(54) HIGH-POWER HIGH-FREQUENCY CABLE

(75) Inventors: Peter WALLMEIER, Lippstadt (DE); Bernd Niehaus, Lippstadt (DE)

(73) Assignee: AEG Power Solutions B.V., Zwanenburg (NL)

(21) Appl. No.: 13/241,881

(22) Filed: Sep. 23, 2011

(30) Foreign Application Priority Data
May 16, 2011 (EP) 11 166 236

(51) Int. Cl. H01B 9/00

(52) U.S. Cl. 174/102 C

(57) ABSTRACT

A high-power high-frequency cable (1) is provided with a strand (2, 3, 2′, 3′, 2″, 3″, 2′″, 3′″) made of electrically conducting individual wires (22) and a jacket (21) implemented as a conductor and surrounding the individual wires (22), wherein each individual wire (22) has an insulating varnish layer, wherein the high-power high-frequency cable (1) has at least one strand pair (2, 3, 2′, 3′, 2″, 3″, 2′″, 3′″) of which one strand (2, 3, 2′, 3′, 2″, 3″, 2′″, 3′″) can be used as a feed conductor and one strand as a return conductor, and wherein the feed conductor and the return conductor of the strand pair (2, 3, 2′, 3′, 2″, 3″, 2′″, 3′″) are bundled so as to run parallel to each other.

### BACKGROUND OF THE INVENTION

(1) Field of the Invention

The present invention relates to a high-power high-frequency cable with a strand made of electrically conducting individual wires and a jacket implemented as a conductor and surrounding the individual wires, wherein each individual wire has an insulating varnish layer.

(2) Description of Related Art

High-frequency currents are used particularly in high-frequency engineering where high-frequency currents are used for signal transmission.

Predominantly, coaxial cables which have an inner conductor made of a wire or strand and an outer conductor made of a braid are used for the transmission of high-frequency signals. A cable with an inner conductor made of a strand is disclosed, for example, in the Swiss patent CH 205040. The cable disclosed in this patent is suitable for transmitting power in excess of 100 kW at high voltages.

A high-frequency strand (HF strand) is also used in high-frequency engineering wherein the individual wires are insulated from each other by a varnish layer although they are at the same potential. This can reduce or eliminate the influence of the skin effect. The overall cross-section of the conductor used for current transport can hereby be increased.

Coaxial cables with rigid conductors, which have a rigid inner conductor and a tube as the outer conductor, have also been described.

So far, no cables are known which are capable of conducting high-frequency currents at high currents of 300 A to 1500 A.

This is where the invention starts.

### BRIEF SUMMARY OF THE INVENTION

It is the object of the invention to provide a high-power high-frequency cable capable of transmitting currents of 300 A to 1500 A with the smallest possible stray fields and losses.

This object is solved with a high-power high-frequency cable which includes at least one strand pair, with one strand of the strand pair being used as a feed conductor and one strand as a return conductor, wherein the feed conductor and the return conductor of the strand pair are bundled so as to run parallel to each other.

The strands of a strand pair run in parallel. To prevent large stray fields and to keep the losses small, the feed conductor and the return conductor run as closely together as possible.

Several, preferably maximally four strand pairs may be bundled in a cable. The bundle is preferably constructed to have a substantially circular cross-section.

With more than four strand pairs, it may be impossible to optimally conduct the heat away which is generated in the strands by the dissipated power and/or the proximity effect may be more evident.

The feed conductor and return conductor, in particular the individual wires, are electrically connected with each other preferably at the ends of the high-power high-frequency cable of the invention. Preferably, cable lugs are used which are soldered and/or crimped. Particularly advantageously, all individual wires are included in this connection, because the cross-section available for conducting the current would otherwise be reduced.

A braided hose is used for mechanical protection. The braided hose prevents damage to the insulation. The hose has preferably a coarse mesh to enable airflow for cooling the strands.

The strands may have 2000 to 4000 individual wires. The individual wires of the strands may have a cross-section of 0.0157 mm².

The individual wires of the strands may be twisted and/or braided.

The cable is preferably designed for a current from 1 A to 1500 A. The average current density at the rated current reaches 8 A/mm². A current conducted through the cable may have a frequency of 1 Hz to 150 kHz.

An exemplary embodiment for a high-power high-frequency cable according to the invention is described with reference to the drawing, which shows in the sole

### BRIEF DESCRIPTION OF THE SEVERAL VIEWS OF THE DRAWING(S)

FIG. 1 a cross-section through the high-power high-frequency cable according to the invention.

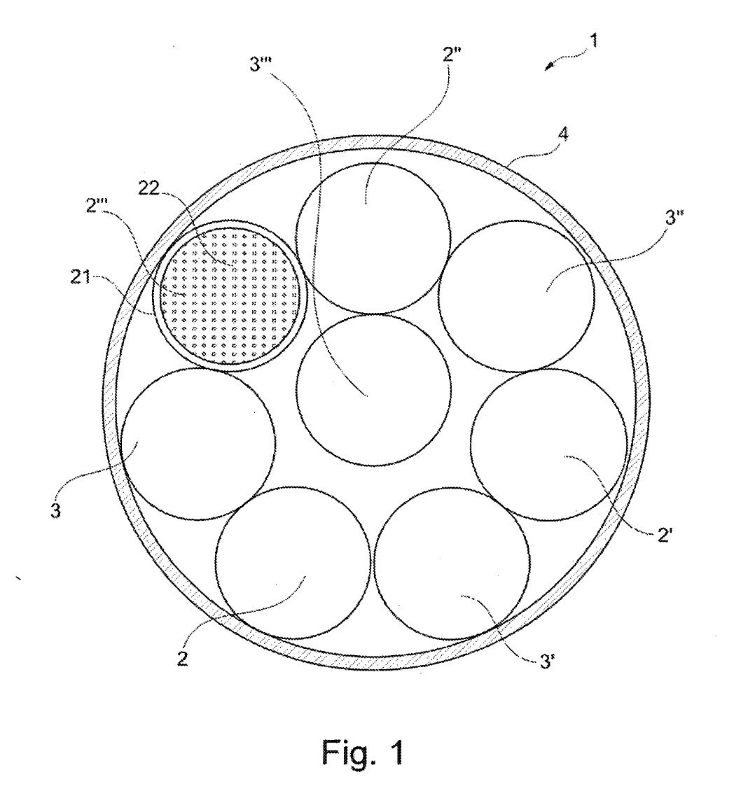

### DETAILED DESCRIPTION OF THE INVENTION

The high-power high-frequency cable 1 according to the invention includes eight high-frequency strands 2, 3, 2′, 3′, 2″, 3″, 2′″, 3′″ which are combined into strand pairs 2, 3; 2′, 3′; 2″, 3″; 2′″, 3′″. The high-frequency strand consists of several individual wires 22 (e.g. 4000), which are insulated with varnish and are braided such that each wire 22 passes each location in the strand 2, 3, 2′, 3′, 2″, 3″, 2′″, 3′″ with the same degree of frequency. By using the strands, the current-carrying area is increased to counteract the negative effects from the skin effect and the proximity effect. The strand 2, 3, 2′, 3′, 2″, 3″, 2′″, 3′″ has a jacket 21 made of a suitable insulating material commensurate with the required isolation voltage.

The strand pairs 2, 3; 2′, 3′; 2″, 3″; 2′″, 3′″ each have a strand configured as a feed conductor 2, 2′, 2″, 2′″ and a strand configured as a return conductor 3, 3′, 3″, 3′″. The feed conductor and the return conductor of a strand pair run parallel to each other and as closely spaced as possible so as to prevent large stray fields and keep the resulting losses small.

The strands 2, 3, 2′, 3′, 2″, 3″, 2′″, 3′″ are inserted in a coarse-meshed braided hose which, on one hand, mechanically protects the strands 2, 3, 2′, 3′, 2″, 3″, 2′″, 3′″, in particular the jackets 21 of the strands 2, 3, 2′, 3′, 2″, 3″, 2′″, 3′″ and, on the other hand, enables adequate airflow through the mesh for cooling the current-carrying components. The four strand pairs 2, 3; 2′, 3′; 2″, 3″; 2′″, 3′″ are bundled in the braided hose 4 of the cable 1 in as round a shape as possible.

1. A high-power high-frequency cable comprising
a strand made of electrically conducting individual wires and
a jacket implemented as a conductor and surrounding the individual wires,
wherein each individual wire has an insulating varnish layer,
wherein the high-power high-frequency cable has at least one strand pair of which one strand is used as a feed conductor and a second strand as a return conductor, and
wherein the feed conductor and the return conductor of the strand pair are bundled so as to run parallel to each other.

2. The high-power high-frequency cable according to claim 1, wherein the high-power high-frequency cable has a plurality of strand pairs, and wherein the strand pairs are bundled so as to run parallel to each other.

3. The high-power high-frequency cable according to claim 2, wherein the high-power high-frequency cable has ends, and wherein at the ends of the high-power high-frequency cable, the feed conductors are connected with one another for electrical conduction, and the return conductors are connected with one another for electrical conduction.

4. The high-power high-frequency cable according to claims 1, wherein the strands are bundled with a coarse-meshed braided hose.

5. The high-power high-frequency cable according to claim 1, wherein the strands comprise about 2000 to about 4000 individual wires.

6. The high-power high-frequency cable according to claim 1, wherein the individual wires of the strands have a cross-section of 0.0157 mm².

7. The high-power high-frequency cable according to claim 1, wherein the individual wires of the strands are twisted and/or braided.
